(19) United States
(12) Patent Application Publication
(10) Pub. No.: US 2008/0040498 A1
(43) Pub. Date: Feb. 14, 2008

(54) System and method of XML based content fragmentation for rich media streaming

(75) Inventors: Vidya Setlur, Cupertino, CA (US); Ramakrishna Vedantham, Sunnyvale, CA (US)

Correspondence Address: FOLEY & LARDNER LLP, P.O. BOX 80278, SAN DIEGO, CA, 92138-0278, US

(73) Assignee: NOKIA CORPORATION

(21) Appl. No.: 11/503,031

(22) Filed: Aug. 10, 2006

(51) Int. Cl. G06F 15/16; G06F 17/00

(52) U.S. Cl. 709/231; 715/234

(57) ABSTRACT

A system and method for partitioning XML-based content into fragments, where transport packets are generated for encapsulating the fragments and streaming the encapsulated fragments to a receiver, such as a mobile device. Fragmentation of the XML-based content can be performed either with or without regard for any underlying XML syntax or structure. In either case, certain relevant fragmentation information is encapsulated with the fragmented XML-based content in the transport packets that allow for various reconstruction, error concealment, and retransmission schemes for presenting the streamed XML-based content on/to the receiver.

### FIELD OF THE INVENTION

The present invention relates generally to XML-based content fragmentation. In particular, the present invention relates to various methodologies for fragmenting XML-based content, while defining and describing the fragments to allow an intended recipient to use the XML-based content even when certain fragments are lost.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Rich media content generally refers to content that is graphically rich and contains compound or multiple media types, including graphics, text, video, and audio. Rich media encompasses a broad range of technologies and implementations, although it is often delivered through a single interface, where the rich media can dynamically change over time as well as respond to user interaction.

Streaming of rich media content is becoming more and more important for delivering visually rich content for real-time transport, especially within the Multimedia Broadcast/Multicast Service (MBMS) and Packet-Switched Streaming Service (PSS) architectures utilized in the 3^{rd} Generation Partnership Project (3GPP). PSS provides a framework for Internet Protocol (IP) based streaming applications in 3^{rd} generation (3G) networks, especially over point-to-point bearers. MBMS streaming services facilitate resource-efficient delivery of popular real-time content to multiple receivers in a 3G mobile environment. Instead of using different point-to-point (PtP) bearers to deliver the same content to different mobile devices, a single point-to-multipoint (PtM) bearer is used to deliver the same content to different mobile devices that are operating within a given cellular coverage area/service area. The streamed MBMS content may comprise video, audio, extensible markup language (XML) content such as Scalable Vector Graphics (SVG), timed-text and other supported media. Furthermore, the streamed content can be pre-recorded or generated from a live feed or source.

Until recently, applications for mobile devices have been text-based with limited interactivity. However, as more mobile devices are being equipped with color displays and more advanced graphics rendering libraries, consumers are beginning to demand a rich media experience from all of their wireless applications. A real-time rich media content streaming service is imperative for mobile devices, especially in the area of MBMS, PSS, and MMS services.

There are several existing systems for representing rich media, particularly in the web services domain, which include XML-based content. SVGT 1.2 is a language for describing two-dimensional graphics in XML. SVG allows for three types of graphics objects: (1) vector graphic shapes (e.g., paths consisting of straight lines and curves); (2) multimedia such as raster images, audio and video; and (3) text. SVG drawings can be interactive (using a DOM event model) and dynamic. Animations can be defined and triggered either declaratively (i.e., by embedding SVG animation elements in SVG content) or via scripting. Sophisticated applications of SVG are possible through the use of a supplemental scripting language which accesses the SVG Micro Document Object Model (uDOM), which provides complete access to all elements, attributes and properties. A rich set of event handlers can be assigned to any SVG graphical object. Because of its compatibility and leveraging of other Web standards such as Compound Documents Format (CDF), features such as scripting can be performed on extensible hypertext markup language (XHTML) and SVG elements simultaneously within the same Web page.

The Synchronized Multimedia Integration Language (SMIL) enables simple authoring of interactive audiovisual presentations. SMIL is typically used for rich media/multimedia presentations which integrate streaming audio and video with images, text or any other media type.

The CDF working group is currently attempting to combine separate component languages (e.g. XML-based languages, elements and attributes from separate vocabularies) such XHTML, SVG, mathematics markup language (MathML), and SMIL, with a focus on user interface markups. When combining user interface markups, specific problems must be resolved that are not addressed by the individual markups specifications, such as the propagation of events across markups, the combination of rendering or the user interaction model with a combined document. This work is divided in phases and two technical solutions: combining by reference and by inclusion.

XML based content has traditionally been transmitted over networks in three modes: (a) download & play (e.g. HTTP/TCP, MMS); (b) progressive download modes; and (c) streaming mode. In modes (a) and (b), the XML client can be assured of the completeness and integrity of the received content. Regarding mode (c), 3GPP and the Open Mobile Alliance (OMA) have recently begun work on the streaming of rich media in the PSS and MBMS frameworks. Real-time Transport Protocol (RTP) is the current, preferred protocol for streaming delivery of continuous media like audio, video, timed-text and SVG.

In enabling the streaming of XML data, an RTP payload format, a set of packetization rules, and error resiliency mechanisms need to be defined. U.S. Provisional Patent Application No. 60/713,303, filed on Sep. 1, 2005 and incorporated herein by reference in its entirety, defines an RTP payload format and some packetization rules. However, the scenario when a large XML document needs to be fragmented across multiple packets is not addressed. A simple approach to fragmenting an XML document involves chopping it into fragments that fit a transport packet size. If an XML client receives all of these fragments, reconstruction of the XML document is trivial. However, if one or more fragments are lost, reconstruction of the XML document becomes challenging, because the fragmentation does not take into account the nesting structure (syntactic property) of the XML content. Therefore, fragmentation methods that exploit the nesting structure of the XML content are needed. Also, given a particular fragmentation method, there is no existing solution as to how the information related to the fragments is signaled in the payload of the transport packet.

Fragmentation can happen at various layers of the Open Systems Interconnection (OSI) model protocol stack when the protocol data unit (PDU) size of a layer is less than that of the upper layer. For example, if an IP packet size is greater than the maximum transport unit (MTU) size, the IP packet needs to be fragmented. Examples include IP fragmentation in IP-based networks, Radio Link Control (RLC) layer fragmentation in the wireless networks, and application-layer fragmentation. Fragmentation at the application layer is preferred to IP-fragmentation.

Application-layer fragmentation was addressed for the real-time transport of compressed video bit streams. For example, Internet Engineering Task Force (IETF) Request for Comments (RFC) 3984 defines fragmentation rules and the corresponding syntax when the compressed video bit stream of a H.264 NAL unit needs to be fragmented into multiple RTP packets.

Currently, there are no solutions focusing particularly on the fragmentation of XML content and information necessary to aid in error recovery and error concealment at the client when one or more of these fragments are lost during transmission. The most recent version of the Mobile Open Rich-media Environment (MORE) proposal in the 3GPP SA4 forum defines a primitive form of fragmentation. It borrows many concepts from IETF RFC 3984, however it does not consider special structure of SVG content (XML syntax) in defining the fragmentation rules.

Certain conventional systems, such as that described in “Structured documents: Searching XML documents via XML fragments” by Carmel et al. exist that extend the vector space model for the purpose of querying XML collections via XML fragments and ranking results by relevance. However, in such systems, the purpose for utilizing XML fragments is to allow a type of free text querying used to access documents expressed in free text, where XML can be used to formulate queries to search relevant XML documents. Document similarity and relevance is performed by extending the vector space information retrieval algorithm based on XPath model, and corresponding documents are retrieved. Thus, the information to be queried is expressed as XML snippets, called XML “fragments.”

Still other prior art systems such as that described in “XML query processing: Query processing of streamed XML data” by Bose et al. focus on processing continuous XML streams, where a server broadcasts XML data concurrently. The server may disseminate XML fragments from multiple documents in the same stream. Clients use a light-weight in-memory database to cache stream data and physical algorithms based on XML algebra to evaluate the XML queries against these data. The focus of such a prior art system is on caching and reconstructing parts of the original XML data just enough for evaluating XML queries against these data. Also, each fragment corresponds to just one XML element from a transmitted document. The server prunes fragments from the XML document tree and has holes in the document for references to the fragments that need to be filled. In addition, the structure of the transmitted XML document is also sent to the client to aid in formulating query grammar for efficient parsing of the partially reconstructed XML content at the client.

U.S. Patent Publication No. 2005/0267909, entitled, “Storing Multipart XML Documents,” incorporated herein by reference in its entirety, describes a method of storing XML documents, by decomposing the XML document into a hierarchy of nodes and creating an index of the nodes. This structure facilitates an indexed-based search for XML content. However, this invention does not consider the problem of fragmenting XML content for streaming purposes, nor any mechanisms for helping the client in error recovery if one or more fragments are lost during transmission.

U.S. Patent Publication No. 2005/0203957, entitled, “Streaming XML data retrieval using XPath,” incorporated herein by reference in its entirety, describes an XML Extractor that can selectively extract a portion of an XML document using XPath-based XML data retrieval. A receiver receives streaming input that represents XML data and a set of XPaths with associated content handler instances for registration. The receiver then evaluates events from the stream-based parser against the registered XPaths and determines whether the received streaming input includes an XPath that matches the registered XPath. Although this process involves the extraction and evaluation of XML data from streamed input, it does not address XML fragmentation and information concerning the transmission of these fragments to enable error recovery.

### SUMMARY OF THE INVENTION

Various embodiments of the present invention provide a system and method for fragmenting XML-based content, encapsulating the content fragments in RTP transport packets, transmitting the RTP transport packets to a receiver, and defining various ways of reconstructing the XML-based content from the fragments to create streamed media. Various rules and options are defined and adhered to by the various embodiments of the present invention when fragmenting XML-based content. The XML-based content can be partitioned into fragments without taking into account any syntactic structure of the XML-based content. Alternatively, various embodiments of the present invention can partition XML-based content in a manner that preserves any underlying syntactic structure or format. In both cases, the XML fragments are extracted and associated with certain relevant fragment information, all of which is transmitted in the RTP transport packet. Upon receipt of the RTP transport packets at the receiver, various methods of reconstructing the XML-based content from the fragments, retransmitting lost packets, and/or performing error concealment can be utilized.

The various embodiments of the present invention provide a method of fragmentation that is not limited simply to, for example, each XML element in a tree hierarchy, but that is driven by permissible transport packet size and optimality to address different needs and applications. In addition, the relevant fragment information transmitted with the fragments can be used to aid in error recovery and error concealment of the XML-based content sample at the receiver end in the event that packets are lost during transmission.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an overview representation of an XML document fragmentation process performed by various embodiments of the present invention;

FIG. 2 is visual example of one embodiment of XML fragmentation implemented by the present invention;

FIG. 3 shows the identification of a packet in the event of packet loss during one embodiment of XML fragmentation implemented by the present invention;

FIG. 4 shows the identification of a group of packets in the event of packet loss during one embodiment of XML fragmentation implemented by the present invention;

FIG. 5a is a representation of a conventional SVG RTP packet;

FIG. 5b is a representation of an SVG RTP packet containing fragmentation units utilized by various embodiments of the present invention;

FIG. 6a is a representation showing a first option for the syntax of a fragment header utilized in one embodiment of the present invention;

FIG. 6b is a representation showing a second option for the syntax of a fragment header utilized in one embodiment of the present invention;

FIG. 6c is a representation showing a third option for the syntax of a fragment header utilized in one embodiment of the present invention;

FIG. 7 shows a visual representation of the nesting rules for XML content utilized in various embodiments of the present invention;

FIG. 8 is a representation of a nesting ID system for an XML document utilized by various embodiments of the present invention;

FIG. 9 shows one example of the identification of a group of packets in the event of pack loss during the second embodiment of XML fragmentation implemented by the present invention;

FIG. 10 shows a second example of the identification of a group of packets in the event of pack loss during the second embodiment of XML fragmentation implemented by the present invention;

FIG. 11 shows a third example of the identification of a group of packets in the event of pack loss during the second embodiment of XML fragmentation implemented by the present invention;

FIG. 12 shows a fourth example of the identification of a group of packets in the event of pack loss during the second embodiment of XML fragmentation implemented by the present invention;

FIG. 13a is a representation showing a first option for the syntax of a fragment header utilized in the second embodiment of the present invention;

FIG. 13b is a representation showing a second option for the syntax of a fragment header utilized in the second embodiment of the present invention;

FIG. 14 is an overview diagram of a system within which the present invention may be implemented;

FIG. 15 is a perspective view of a mobile device that can be used in the implementation of the present invention; and

FIG. 16 is a schematic representation of the circuitry of the mobile device of FIG. 15.

### DETAILED DESCRIPTION OF THE VARIOUS EMBODIMENTS

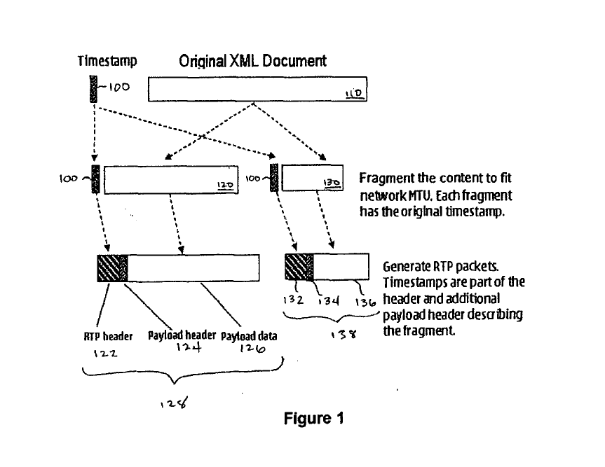

Various embodiments of the present invention describe a method of fragmenting XML-based data, as for example, in an XML document, at a server or similar network element, and the subsequent formation and transport of this fragmented data from the server to a receiver. These embodiments of the present invention include two types of XML fragmentation techniques, i.e., Brute Force and Syntactic Based. Brute force based fragmentation fragmentation involves an arbitrary splitting of XML data based on MTU size without taking into consideration the syntactic structure of the XML content. Syntactic based fragmentation involves the splitting of XML data based on MTU size taking the underlying syntactic structure of the XML content into consideration. In addition, the payload representations for each of these techniques are described herein. A generalized overview of this process is illustrated in FIG. 1. A timestamp 100 is shown as being associated with an original XML document 110. The original XML document 110 is partitioned into two fragments, 120 and 130, each fragment having the original timestamp 100 associated therewith. It should be noted that fragments 120 and 130 have each been fragmented to fit into a defined network MTU. In addition, RTP packets are generated for each of the fragments 120 and 130. For example, RTP packet 128 is generated to contain an RTP header 122, a payload header 124, and payload data 126, where the payload data 126 comprises the data contained in the fragment 120. Likewise, RTP packet 138 is generated to contain its own RTP header 132, payload header 134, and payload data 136, where the payload data 136 comprises the data contained in the fragment 130. It should also be noted that other appropriate transport protocols may be used to transmit the fragments 120 and 130. It should be noted that if a given XML document does not fit a specified network's MTU, the XML document is fragmented into several fragments such that each fragment satisfies the given MTU size. These fragments are then encapsulated as RTP packets for transmission.

The various embodiments of the present invention also provide different methodologies and rules for fragmenting XML data and for subsequent representations of the payload format that define and describe such fragments. The rules define the manner in which the XML data can be split, i.e., at the appropriate places, along with payload headers to help a receiver of the fragmented XML data to still be able to use the data in the event that one or more fragments are lost before reaching the receiver.

Several common use cases for which the fragmentation of XML-based content can be utilized for streaming purposes are described below. It should be noted, however, that there are a plurality of other uses for which the fragmentation of XML-based content could be performed. One such common use involves Interactive TV (iTV) Mobile services. The iTV Mobile service is understood as having the ability to provide a deterministic rendering and behavior of rich media content, which includes audio-video content, text, images, XML based content such as SVG, together with TV and radio channels in an end user interface. The iTV Mobile service provides convenient navigation through content in a single application or service and allows synchronized interaction both locally and remotely. For example, the iTV Mobile service allows users to perform actions such as voting and personalization (e.g.: related menus or sub-menus, advertising and content relating to an end-user profile or service subscription.

The iTV use case can be described in four steps which correspond to four services and sub-services available in an iTV mobile service. The first service is an iTV profile/menu service having the following sub-services: (1) Mosaic menu: TV Channel landscape; (2) Electronic Program Guide and triggering of related iTV service; (3) actual iTV service; and (4) Personalized Menu “sport news.” The second service can comprise a live enterprise data feed, where stock tickers that stream real-time quotes, live intra-day charts that show technical indicators, and news monitoring, weather alerts, charts, business updates, etc. are provided. The third service can comprise live chat. The live chat service can be incorporated within, but not limited to a web cam, video channel, or rich media blog service. End users can register, save their surname and exchange messages. Live chat messages appear dynamically in the live chat service along with rich media data provided by the end user. The live chat service can be either private or public in one or more channels at the same time. End users are dynamically alerted when new messages from other users arrive. Dynamic updating of messages within the live chat service can also occur without reloading a complete page. The fourth exemplary service is karaoke, where a music TV channel or video clip catalog is displayed together with the animated lyrics of a song. The animated lyrics can comprise fluid-like animation applied to the text characters of the song's lyrics in order to make the text characters appear as though they were being sung along with the song (e.g., smooth color transition of fonts, scrolling of text, etc.) The end user is then able to download a song of his/her choice along with the complete animated lyrics by selecting an interactive button.

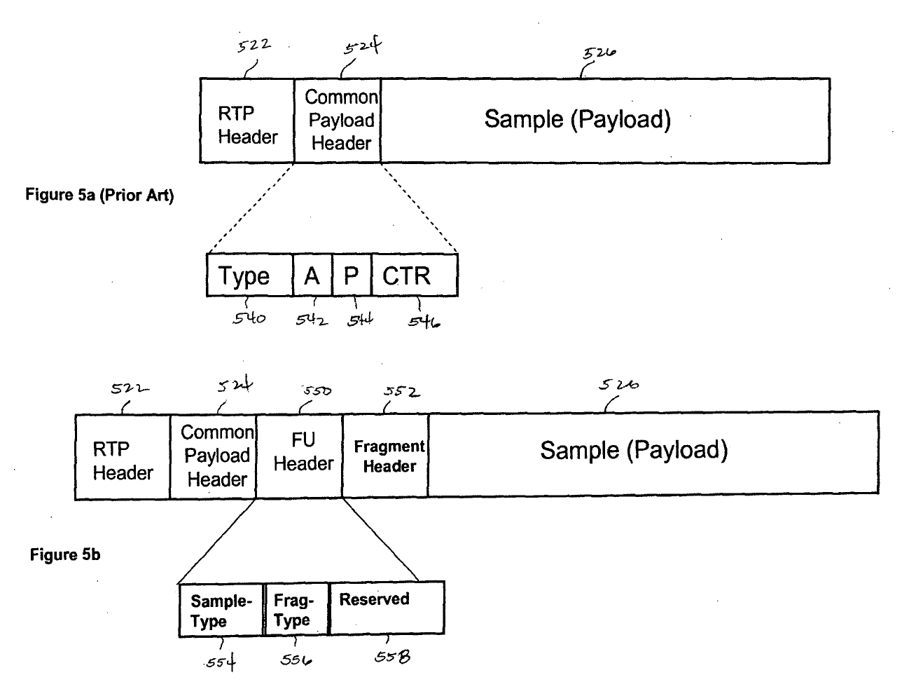

As discussed above, an RTP payload is used to describe and/or define an XML data fragment. Therefore, an RTP payload format is also defined. A prior art RTP packet format is shown in FIG. 5a, where a common payload header 524 comprises a type field 540, which indicates the type of payload that content sample/payload 526 comprises, an “A” flag 542, a priority (P) flag 544, and a counter (CTR) field 546. The A flag 542 comprises a single bit field, which when set to one indicates that a packet either is, or contains, a random access point. The P field 544 indicates that priority associated with the payload, i.e., some payloads that have a higher priority may be transmitted on a more reliable channel than that used to transmit a payload of lower priority. The CTR field 546 that is incremented by one for each new packet of corresponding priority.

FIG. 5b shows an RTP packet format used in the various embodiments of the present invention. In addition to the RTP header 522, the common payload header 524, and the payload 526, a fragmentation unit (FU) header 550 which follows the common payload header 524 and a fragment header 552 which in turn follows the FU header 550 are also defined. It should be noted that although it is not shown in FIG. 5b, the common payload header 524 is comprised of the same fields as described above in FIG. 5a. In the case of fragmented packets, the type field 540 is set to 6, indicating that the payload 526 is an FU. In contrast, conventional RTP packets generally have 5 types of payloads defined, where a type 1 packet contains one or more sample description(s), a type 2 packet contains a complete SVG scene sample or one of its fragments, a type 3 packet contains a complete SVG update sample or one of its fragments, a type 4 packet contains a list of SVG elements that are currently active, and a type 5 packet contains sample dissimilarity information.

The syntax of the FU header 550 is also shown in FIG. 5b. A 3-bit sample type field 554 indicates the type of the sample contained in the fragmentation unit. The sample type field 554 can take on one of the following five values: 0 indicates a distributed random access point; 1 indicates a sample description; 2 indicates a scene; 3 indicates a scene update; and 4 indicates sample dissimilarity information. It should be noted that the sample type field 554 do not take values 5, 6, or 7. A 2-bit fragmentation type field 556 indicates the semantics of the fragmentation used in forming the fragmentation units. The fragmentation type field 556 can take on one of the four following values: 0 indicates brute force XML fragmentation; 1 indicates syntactic fragmentation; 2 is reserved; and 3 is reserved. The remaining 3-bit reserved field is reserved for possible future extensions.

The syntax of the fragment header 552 depends on the fragmentation type 556 indicated in the FU header 550. For various values of the fragmentation type, the syntax and semantics of the fragment header are described below.

For each fragmentation-type, the syntax of the fragmentation header will satisfy certain requirements. For a lossless case, where no fragments are lost, the syntax enables a receiver to reassemble the content sample from its fragments when all fragments are received. For a lossy case, when one or more fragments of a content sample are lost, the syntax may allow the receiver to conceal the effect of packet loss on the reassembled sample.

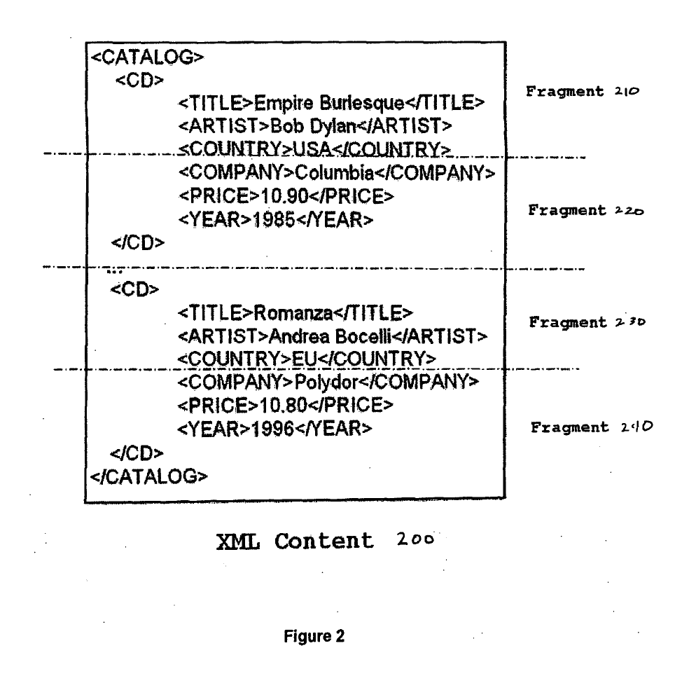

In one embodiment of the present invention, a first type of fragmentation, referred to as brute force XML fragmentation, can be utilized. This embodiment of XML fragmentation involves an arbitrary splitting of XML data based on MTU size without taking into consideration the syntactic structure of the XML content. FIG. 2 illustrates an example of brute force XML fragmentation, where XML content 200 is fragmented into fragments 210, 220, 230, and 240 without regard for where the fragment partitions are made. For example, the element “CD” is partitioned between its “country” and “company” sub-elements, creating the fragments 210 and 220.

When brute force XML fragmentation is utilized, as shown in FIG. 2, the XML data is easily fragmented into its respective fragments, 210, 220, 230, and 240. If all of the fragments 210, 220, 230, and 240 are received by the receiver, the XML content is easy to reconstruct. However, if one or more of the fragments 210, 220, 230, and/or 240 is/are lost, it is difficult for the receiver to reassemble the data because the receiver has no knowledge of the nesting structure of the XML content. In addition, error concealment is also difficult to perform because if fragments are lost, brute force XML fragmentation relies mainly on the retransmission of lost fragment packets.

Three possible options exist regarding a fragment header syntax for brute-force fragmentation: (0) Start flag, End flag; (1) Sample ID; (2)

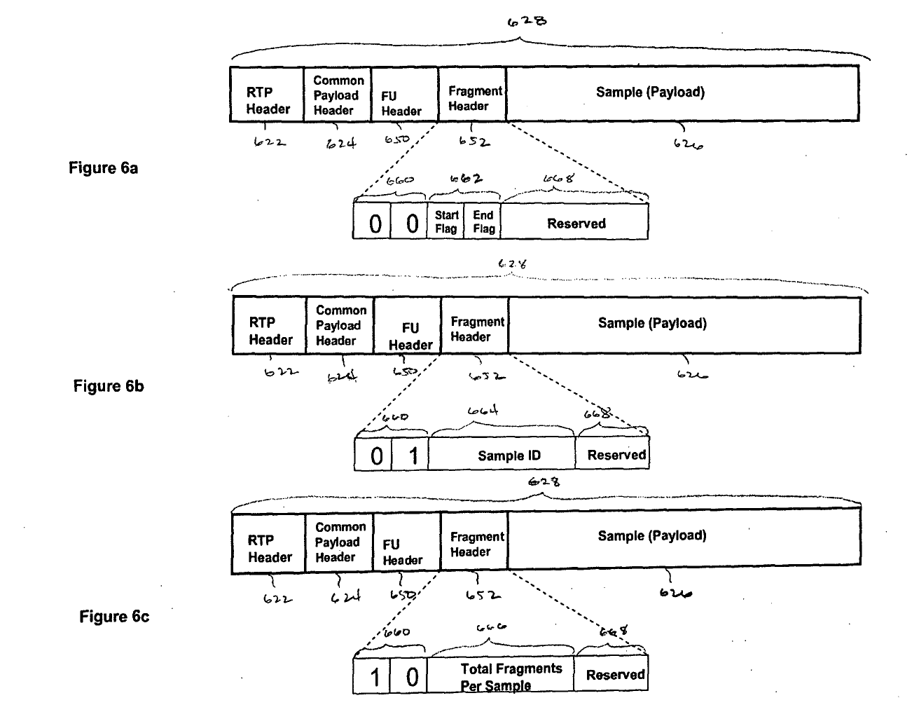

TotalFragmentsPerSample. They are summarized with their associated advantages and disadvantages in Table 1 and illustrated in FIGS. 6a, 6b, and 6c. Although all three options satisfy the lossless requirement described above, error-recovery is difficult when brute-force fragmentation is used. Therefore, a minimal number of bits are used to satisfy the lossy requirement described above.

TABLE 1
Options for Fragment-header syntax for brute-force fragmentation

| Fragment- | | | | |
|---|---|---|---|---|
| header syntax | Description | Overhead | Advantages | Disadvantages |
| Option 0: | Start flag is set in the | 2 bits | Low | Does not help in |
| Start flag, End | first fragment of a | | overhead | error recovery |
| flag | sample. | | | |
| | End flag is set in the | | Easy to | |
| | last fragment of the | | parse | |
| | same sample. | | | |
| Option 1: | All fragments of one | 4 bits | Easy to | Does not help in |
| Sample ID | sample share the same | | parse | error recovery |
| | Sample ID. | | | |
| Option 2: | Each fragment | 4 bits | Helps the | |
| TotalFragments | contains the total | | receiver in | |
| PerSample | number of fragments | | error | |
| | in the sample. | | recovery. | |

FIG. 6a shows an RTP fragment packet 628, where the fragment header 652 comprises a 2-bit binary syntax identifier 660, indicating option 0, start and end flag fields 662, and reserved field 668. FIG. 6b shows the RTP fragment packet 628, where the fragment header 652 in this case comprises a 2-bit binary syntax identifier 660, indicating syntax option 1, a sample ID field 664, and a reserved field 668. FIG. 6c shows the RTP packet 628, where the fragment header 652 in this case comprises a 2-bit binary syntax identifier, indicating syntax option 2, a TotalFragmentsPerSample field 666, and a reserved field 668.

Focusing on the third syntax option, for error recovery, a receiver can first identify the missing fragments from the syntax of the received fragments. As shown in Table 1, among the three options, the third syntax helps the receiver in determining the fraction of the missing fragments. The receiver may then decide whether to request retransmission of any missing fragment packets or to perform error-concealment by engaging in post-processing. Although sequence numbers associated with each RTP packet allows the receiver to know the proper ordering of the RTP packets, and consequently, whether any RTP packet is missing, they do not inform the receiver of which particular XML sample any one fragment is a part. Therefore, in addition to sequence numbers, the total number of fragments that comprise a sample is also provided with each fragment. If packet loss occurs, the receiver can correctly estimate how many fragments of a particular sample are in fact missing. In addition, the P flag in the common payload header informs the receiver what the priorities of the missing fragments are, while the TotalFragmentsPerSample informs how much percentage of a given sample is lost. Hence, these two types of information at different granularities, help facilitate selective retransmission of any lost fragment packets.

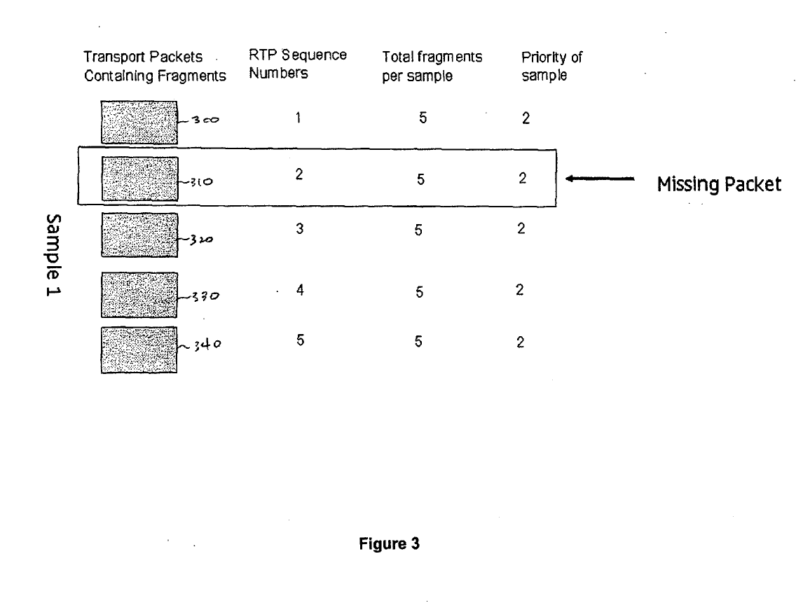

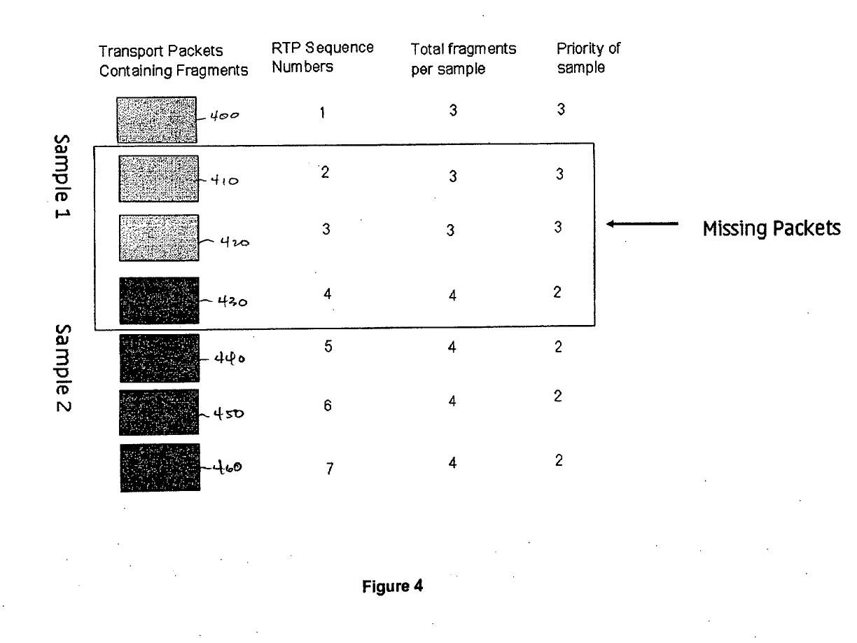

FIGS. 3 and 4 illustrate how information associated with fragments can be used to determine packet loss and what the receiver could decide to do in such a packet loss event. In particular, FIG. 3 shows one method of identifying a packet in the event of packet loss in brute force XML fragmentation. A sample 1 is shown, the content of which is partitioned into RTP transport packets 300-340, each containing a fragment of sample 1. The RTP transport packets 300-340 are each associated with an RTP sequence number, i.e., 1-5, respectively. As described above, when the third syntax of brute force XML fragmentation is utilized, the fragment header of each of the RTP transport packets 300-340 contain a TotalFragmentsPerSample field indicating the total number of fragments into which a sample was partitioned. Here, the total number of fragments is five. In addition, each of the RTP transport packets 300-340 have an equal priority of 2. If, for example, RTP transport packet 310 was lost, the receiver can determine this packet loss from the RTP sequence numbers. Therefore, because the receiver knows that the second RTP transport packet 310 is missing, and it knows that it is one of five fragments of sample 1, with priority of 2, the missing RTP transport packet 310 can either be retransmitted. Alternatively, error correction may be performed at the receiver since the majority of the sample 1 packets have arrived. It should be noted that the RTP sequence number and the P flag are already defined in the generic SVG RTP packet format of FIG. 5a, described above.

FIG. 4 shows another method of identifying a group of packets in the event of packet loss in brute force XML fragmentation. In this scenario, two samples, sample 1 and sample 2 are shown, where the content of sample 1 is partitioned into three fragments, each fragment being contained in an RTP transport packet, 400-420 respectively. Sample 2, on the other hand, is partitioned into 4 fragments, each of which is contained in at RTP transport packet 430-460 respectively. RTP sequence numbers 1-7 are assigned to each of the RTP transport packets 400-460, where the RTP transport packets 400-420 each have a TotalFragmentsPerSample value of 3, while each of the RTP transport packets 430-460 have a TotalFragmentsPerSample value of 4. Lastly, the RTP transport packets 400-420 are each associated with a sample priority of 3, while the RTP transport packets 430-460 are each associated with a sample priority of 2.

As described with regard to FIG. 3, from the RTP sequence numbers a receiver can determine that the second, third, and fourth RTP transport packets, i.e., 410, 420, and 430, are missing. From the total fragments in each sample, the receiver can also determine that the first two missing RTP transport packets 410 and 420 belong to sample 1. In addition, the receiver knows the RTP transport packets 410 and 420 comprise 2 or 3 fragments of sample 1, with a priority of 3. The last missing RTP transport packet 430 can be determined by the receiver to belong to sample 2 with priority 2. Because the missing RTP transport packets 410 and 420 of sample 1 have a high priority, each can be retransmitted since only one-third of the content of sample 1 was received by the receiver or XML client. Regarding sample 2, three-fourths of the content of the sample 2 was received, and has a lower priority. The receiver may then choose to simply apply error concealment to sample 2.

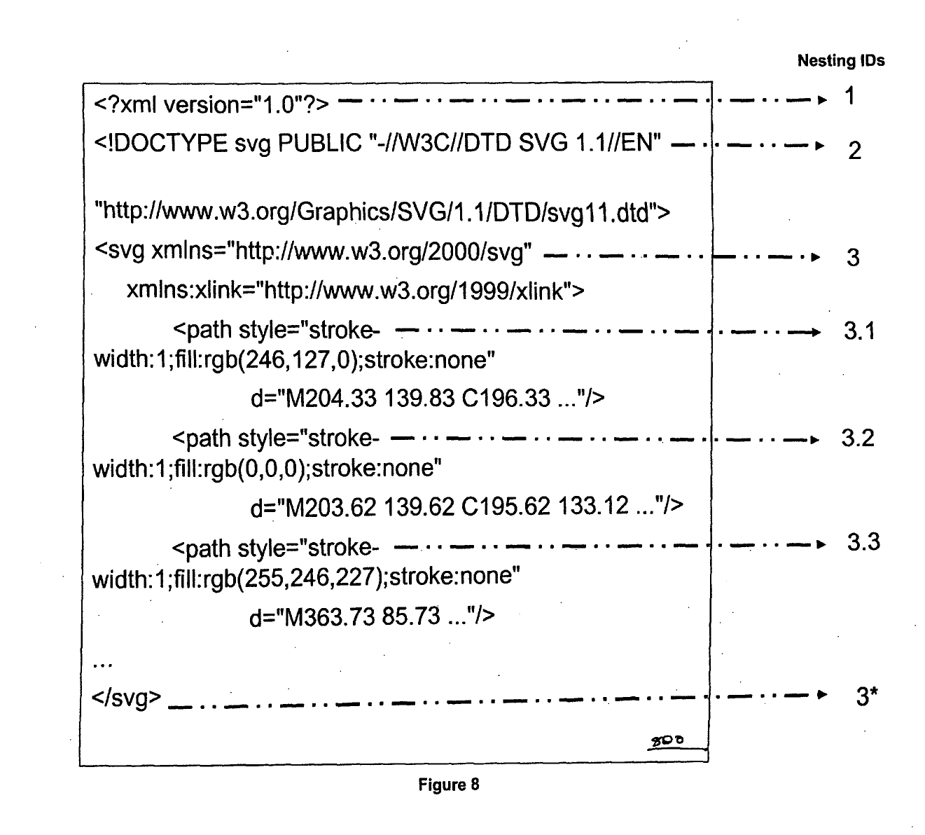

In another embodiment of the present invention, a method of XML fragmentation referred to as syntactic XML fragmentation is utilized, which involves the splitting of XML data based on MTU size. In addition, the underlying syntactic structure of the XML content is taken into consideration. FIG. 8 illustrates how an XML document 800 is partitioned according to syntactic XML fragmentation. It should be noted that the XML document 800 contains nested elements, i.e., “path style” within the “svg” element. Each partition that is to comprise a fragment is denoted by a nesting ID. FIG. 8 illustrates 7 partitions denoted by nesting IDs, 1, 2, 3, 3.1, 3.2, 3.3, and 3*, where the “0.1,” “0.2,” and “0.3” denote the level of nesting from the parent node or element, and the “*” denotes a corresponding end tag of the parent element.

If packet loss is experienced when utilizing syntactic XML fragmentation in an embodiment of the present invention, it is relatively easy for a receiver to reassemble XML data without errors in XML document object model (DOM) reconstruction because the nesting structure of the XML content is known. In addition, it is easy to perform error concealment if fragment packets are lost. However, a higher level of complexity is encountered when fragmenting XML data using syntactic XML fragmentation. Moreover, in a scenario where it is known that either all fragments are received by the receiver or very few fragments are lost, syntactic XML fragmentation may be viewed as extra overhead, both for fragmentation and reassembly purposes. In such a case, brute force XML fragmentation may be a preferable approach.

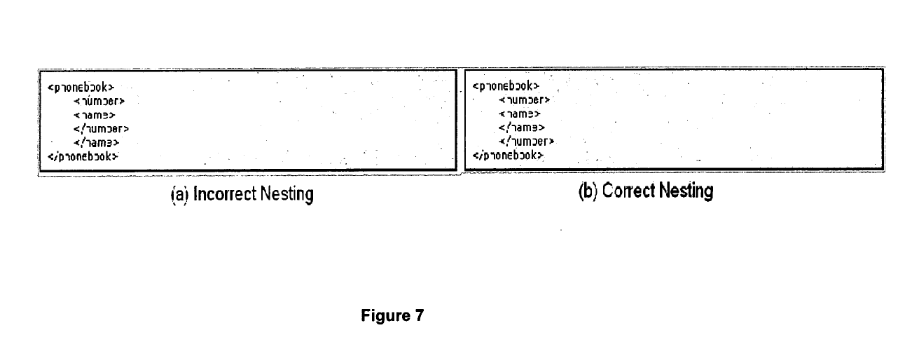

Referring to FIG. 8, XML documents often contain elements that appear within another element, i.e., “nesting”. Nesting can serve the purpose of keeping order in an XML document. Therefore, an element which is nested inside another element, i.e., a parent node or element, needs to end before that parent element. Hence, in order to construct a DOM correctly, certain rules are generally adhered to, such as elements that are opened first must be closed last. Another applicable rule is that nested elements, i.e., elements that occur in the middle of an XML document, need to be closed before those elements that came before them. FIG. 7 illustrates an example of correct and incorrect nesting arrangements. Example (a) shows that nested element “name” has not been closed before the element “number.” Example (b) on the other hand, shows that the nested element “name” has been closed prior to the closing of element “number.”

Where the fragmentation of XML content is concerned, there is a correlation between the above-mentioned nesting properties (i.e., syntactic structure) that the XML content exhibits and correct reassembly of its fragments at a receiver. By having prior knowledge of the syntactic structure of the XML content, the receiver is more intelligent in terms of how the fragments can be re-assembled. Because brute force XML fragmentation does not take the syntactic structure of XML content into consideration, it mainly relies on retransmission for correct DOM reconstruction in the event of packet loss. However, if there is a predictable chance that frequent small-scale packet loss occurs, syntactic XML fragmentation provides a more efficient way of DOM reconstruction. In order to store the appropriate syntactic information with the fragments for transmission and reassembly, various embodiments of the present invention utilize a nesting representation with corresponding nesting IDs. One embodiment of such a representation is depicted in FIG. 8, as described above.

Certain rules should be observed as well when utilizing nesting IDs. These include: (1) Only nesting IDs belonging to one sample are stored in each packet. In other words, nesting IDs belonging to different samples are not included in the same packet; (2) For each XML fragment, if more than one nesting ID is stored in the fragment, and all child elements are contained within the parent element, only the nesting ID of the outermost element is stored as the inner content is automatically included. For example, again referring to FIG. 8, if the XML content represented by nesting IDs 3, 3.1, 3.2, and 3.3 are in the same packet, then only the value 3 is stored as a nesting ID with the fragment packet; and (3) For each XML fragment, if more than one nesting ID is stored in the fragment, and not all the child elements are contained within the parent element, then all of the individual nesting IDs are stored. For example, in FIG. 8, if only the XML content represented by nesting IDs 3, 3.1 are contained in the same fragment packet, both values, 3 and 3.1, are stored as nesting IDs with the fragment packet.

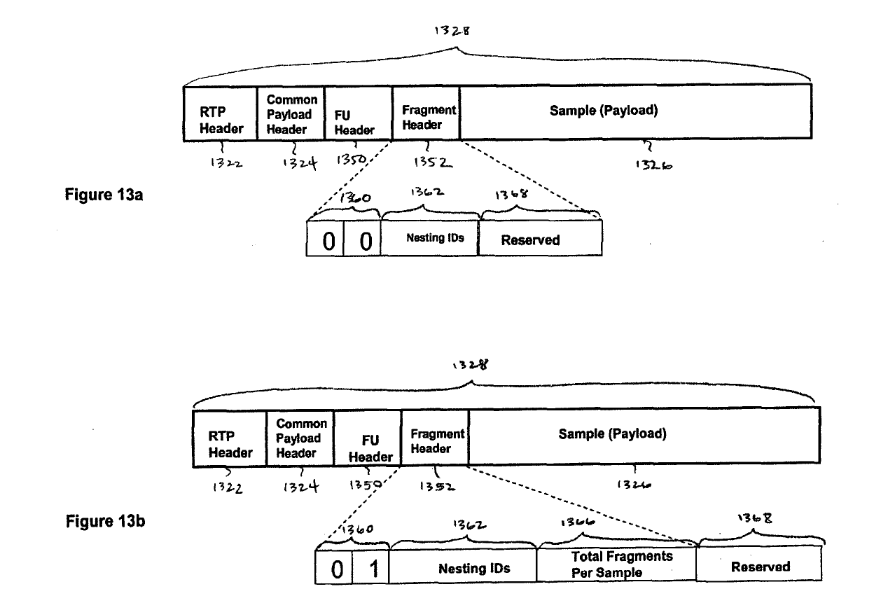

As is the case with brute force XML fragmentation, several possible options for the fragment header syntax in syntactic XML fragmentation also exist. These options are summarized in Table 2 with their respective advantages and disadvantages, and illustrated in FIGS. 13a and 13b. It should be noted that all of the fragment header syntaxes for syntactic XML fragmentation meet the lossy requirement discussed above. It should further be noted that additional bits are used to store the nesting IDs as will be described below.

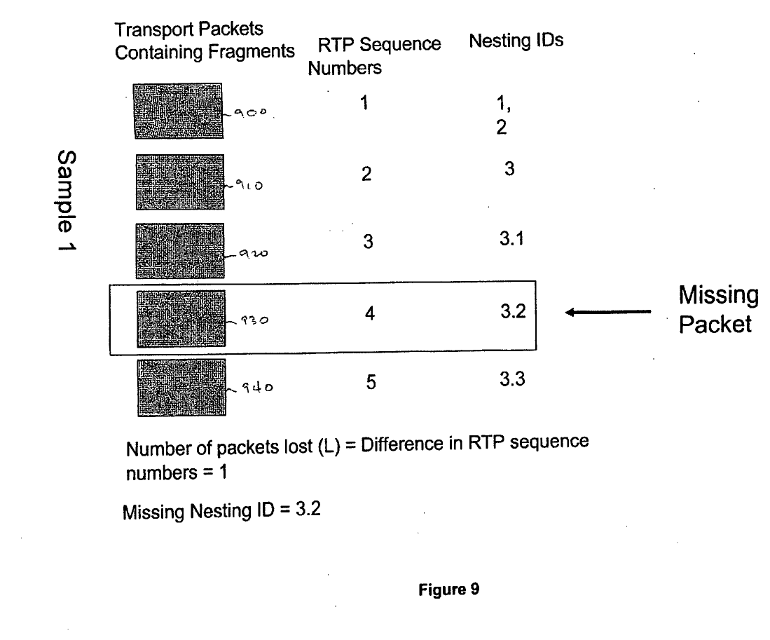

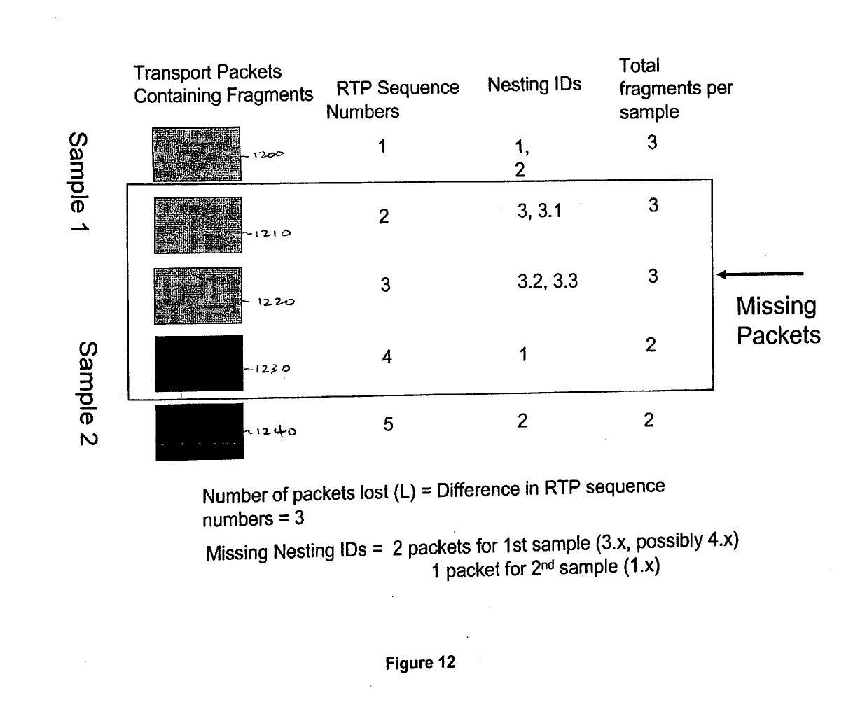

TABLE 2
Options for Fragment-header syntax for syntactic fragmentation

| Fragment | | | | |
|---|---|---|---|---|
| header syntax | Description | Overhead | Advantages | Disadvantages |
| Option 0: | Stores only | String of | Lowest overhead | Possible for |
| Nesting ID | the nesting | varying | among the various | ambiguity in the |
| | IDs with each | length | options for | event of multiple |
| | fragment. | | syntactic | packet loss. |
| | | | fragmentation. | Refer to FIGS. 9, |
| | | | Helps the receiver | 10, and 11 for |
| | | | in error recovery | examples. |
| | | | and concealment. | |
| | | | Suitable for error | |
| | | | concealment when | |
| | | | very frequent | |
| | | | occurrence of | |
| | | | small packet loss | |
| | | | happens. | |
| Option 1: | Each | 4 bits + String | No ambiguities in | Additional |
| TotalFragments | fragment | of | the event of | overhead. Refer |
| PerSample, | contains the | varying | multiple packet | to FIG. 12. |
| Nesting ID | total number | length | loss as shown in | |
| | of fragments | | FIG. 12. | |
| | in the sample | | Helps the receiver | |
| | along with | | in error recovery | |
| | corresponding | | and concealment. | |
| | nesting IDs. | | Suitable for error | |
| | | | concealment when | |
| | | | very frequent | |
| | | | occurrence of | |
| | | | large packet loss | |
| | | | occurs. | |

For error recovery when utilizing syntactic XML fragmentation, a receiver should be able to first identify the missing fragments from the syntax of the received fragments. Among the two options summarized in Table 2, Syntax Option 1 helps the receiver in determining the fraction of the missing fragments with minimal ambiguity. Syntactic fragmentation can help the receiver to perform error concealment by reconstructing the DOM correctly by either excluding the missing elements or “guesstimating” the missing information from the content received. Such error concealment methods can be used rather than retransmission particularly when frequent packet loss occurs. This prevents the frequent retransmission of missing packets, which can tie up transmission resources and increase traffic.

In syntactic XML fragmentation, similar to brute force XML fragmentation, the P flag in the common payload header informs the receiver what the priorities of the missing fragments are. This information is important as it allows the receiver to decide whether to request retransmission or perform error concealment. While in brute force XML, priority assignment for a particular sample is determined at the authoring level, in syntactic based fragmentation, priority can depend on the nesting property of the XML content. Basically, a given element with many children can be deemed to be important and assigned a high priority. For example, in SVG, the “svg” element, which is denoted by the <svg> and </svg> tags are the outermost tags in an SVG, XML document, and hence have a large number of children. Therefore, a rule for assigning priority can be represented as follows: If C(E)>Tᵢ then mark E as Pᵢ; where, C(E) denotes the number of children of element E, Tᵢ is the threshold number used to demarcate a particular priority Pᵢ, and 0<=i<=N, where N is the total number of priorities that can be assigned to the fragment packets. In the event of packet loss, if the priority of the missing packet is high, the receiver can opt for retransmission rather than error concealment and vice-versa.

FIG. 13a shows an RTP fragment packet 1328, where the fragment header 1352 is comprised of a 2-bit, binary syntax identifier indicating syntax option 0, a nesting ID field 1362, and a reserved field 1368. FIG. 13b shows an RTP fragment packet 1328, where the fragment header 1328 is comprised of a 2-bit, binary syntax identifier indicating syntax option 1, nesting ID field 1362, TotalFragmentsPerSample field 1366, and a reserved field 1368.

FIG. 9 shows a method of identifying a group of fragment packets in the event of packet loss utilizing syntactic XML fragmentation using nesting IDs: A content sample 1 is shown as being partitioned into five fragments, each of which is contained in RTP transport packets 900-940, respectively. From the RTP sequence numbers a receiver can determine that the fourth RTP transport packet 930 is missing. From the nesting IDs for the third and fifth RTP transport packets 920 and 940, the receiver can further infer that the missing RTP transport packet 930 belongs to content sample 1. Although retransmission could be used for the missing RTP transport packet 930, it is also possible to apply error concealment and reconstruct an XML DOM correctly with balanced nested elements based on the nesting ID information associated with each of the RTP transport packets 900-940. It should be noted that a value L can denote the number of RTP transport packets that are lost, where L equals the difference in RTP sequence numbers.

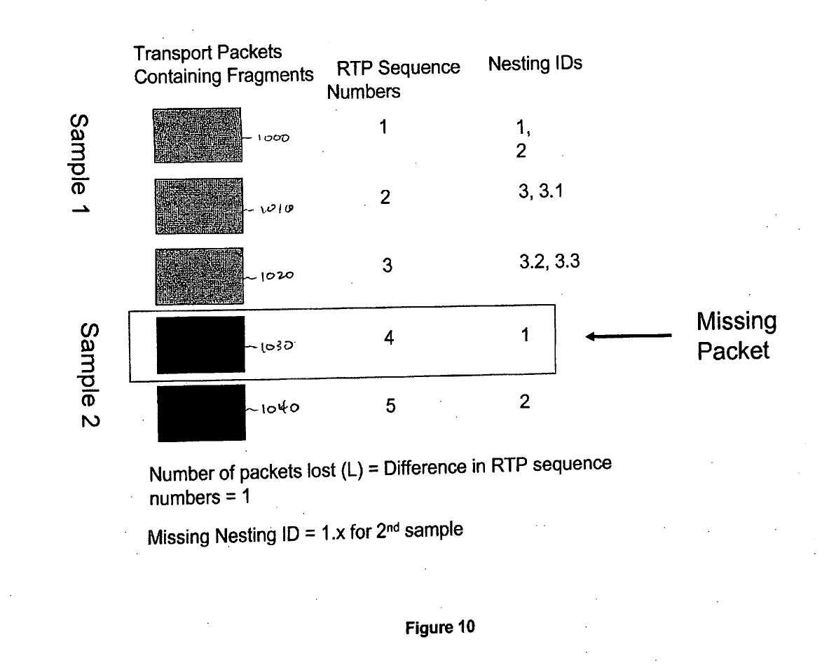

FIG. 10 shows another method of identifying a group of fragment packets in the event of packet loss utilizing syntactic XML fragmentation using nesting IDs: A content sample 1 is shown as being partitioned into three fragments, each of which is contained in RTP transport packets 1000-1020, respectively. A content sample 2 is also shown, where the content sample 2 is partitioned into two fragments, each of which is contained in RTP transport packets 1030 and 1040, respectively. From the RTP sequence numbers a receiver can determine that the fourth RTP transport packet 1030 is missing. From the nesting IDs for the fifth RTP transport packet 1040, the receiver can infer that the missing RTP transport packet 1030 belongs to sample 2. Although retransmission could be used for the missing packet, it is possible to apply error concealment and reconstruct an XML DOM correctly with balanced nested elements based on the nesting ID information.

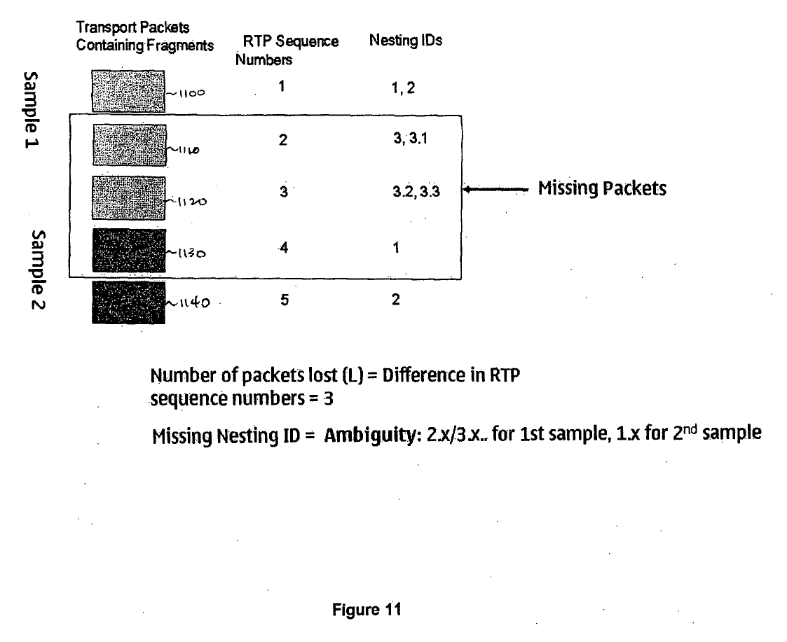

FIG. 11 shows yet another method of identifying a group of fragment packets in the event of packet loss in syntactic XML fragmentation using nesting IDs. A content sample 1 is shown as being partitioned into 3 fragments, each of which is contained in RTP transport packets 1100-1120, respectively. Another content sample 2 is also shown as being partitioned into 2 fragments, each of which is contained in RTP transport packets 1130 and 1140, respectively. From the RTP sequence numbers a receiver can determine that the second, third and fourth RTP transport packets 1110-1130 are missing. In this scenario however, it is unclear from which RTP transport packet onward, that the fragment belongs to sample 2. For instance, nesting ID 1.x for content sample 2 can start from packet 2, 3 or 4. This ambiguity makes XML reconstruction less trivial.

FIG. 12 shows another method of identifying a group of packets in the event of packet loss in syntactic XML fragmentation using nesting IDs and TotalFragmentsPerSample. A content sample 1 is shown as being partitioned into 3 fragments, each of which is contained in RTP transport packets 1200-1220, respectively. Another content sample 2 is also shown as being partitioned into 2 fragments, each of which is contained in RTP transport packets 1230 and 1240, respectively. From the RTP sequence numbers a receiver can determine that the second, third and fourth RTP transport packets 1210-1230 are missing. The receiver also can determine from the TotalFragmentsPerSample values for each of the content samples 1 and 2, that two of the missing RTP transport packets 1210 and 1220 belong to content sample 1, comprising nesting IDs 3.x and possibly 4.x. The last of the missing RTP transport packets, i.e., RTP transport packet 1230, belongs to content sample 2 with and associated nesting ID value of 1.x.

Other alternative embodiments of the present invention are still possible. In one alternative embodiment, brute force XML fragmentation can be modified by reordering fields in the fragment header. Brute force XML fragmentation can also be modified to specify the minimum possible size of fields in the payload format. This is useful for reducing overhead since certain fields can be longer than the specified values contained in those fields. Brute force XML fragmentation can be further modified by utilizing a different notation for the fields in the payload. Likewise, syntactic XML fragmentation can also be modified by reordering fields in the fragment header. Syntactic XML fragmentation can be modified by specifying a possible size for the fields in the fragment header, where some fields can be shorter or longer than the specified values contained in those fields. Yet again, syntactic XML fragmentation can be modified by using a different notation for the fields in the fragment header. The nesting ID arrangement described above that can be used in syntactic XML fragmentation, can also be varied, although the general idea of storing nesting IDs in the payload is agnostic of the arrangement itself. Priority assignments based on an XML syntactic structure used in syntactic XML fragmentation 2, can also vary, although like the varying of nesting IDs, the general idea of determining priority based on the nesting level of the various XML elements is agnostic of the scheme itself.

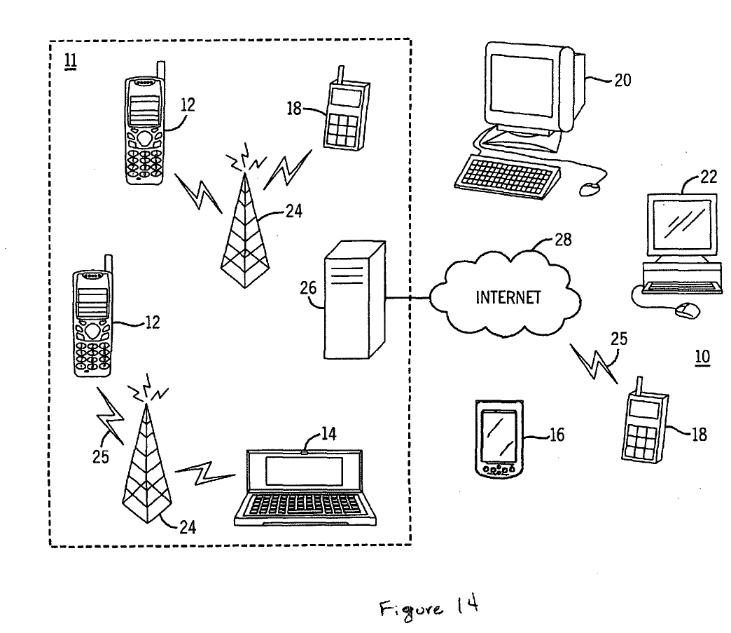

FIG. 14 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 14 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile device 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, Digital Video Broadcast-Handheld (DVB-H), Internet Protocol Device Control (IPDC), Media FLO, etc. A communication device may communicate using various media including, but not limited to, radio, infrared, laser, cable connection, and the like.

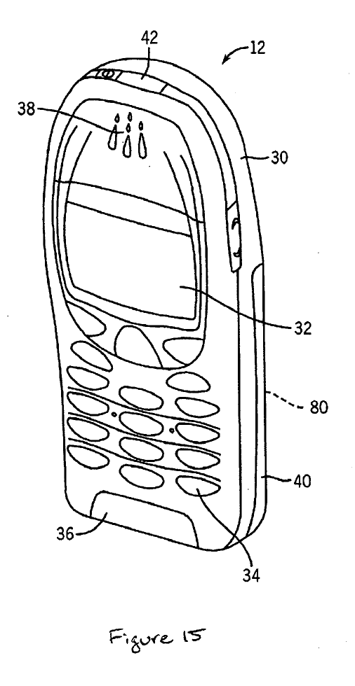

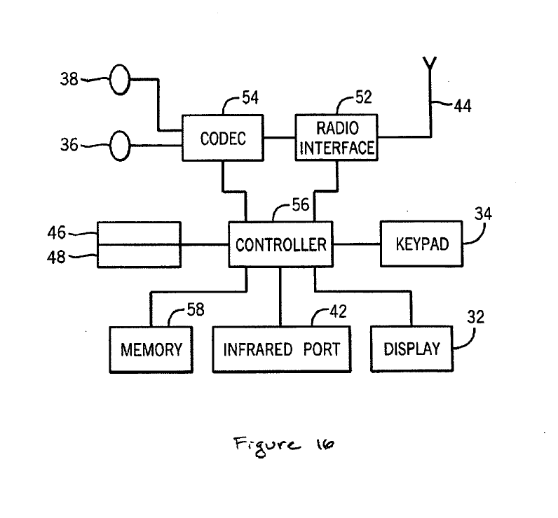

FIGS. 15 and 16 show one representative mobile device 12 for receiving fragment packets. It should be understood, however, that the present invention is not intended to be limited to one particular type of mobile device 12 or other electronic device. The mobile device 12 of FIGS. 15 and 16 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of streaming content to a receiver, comprising:
partitioning at least one XML-based content sample into at least two fragments;
generating a transport packet for each of the at least two fragments;
encapsulating each of the at least two fragments in a payload field within their respective transport packets, wherein each of the respective transport packets also contains a fragmentation type field; and
transporting the respective transport packets for reassembly of the at least one XML-based content sample at the receiver using the at least two fragments.

2. The method of claim 1, wherein the transport packet further comprises a sample type field indicating a type of content that is contained in the payload field.

3. The method of claim 1, wherein the fragmentation type field indicates a type of partitioning performed on the at least one XML-based content sample.

4. The method of claim 3, wherein the type of partitioning performed on the at least one XML-based content sample comprises partitioning the at least one XML-based content sample into fragments regardless of any underlying syntactic structure associated with the at least one XML-based content sample.

5. The method of claim 4, wherein the transport packet further comprises at least a header syntax identifier, a start flag set in a first one of the at least two fragments, and an end flag set in a last one of the at least two fragments.

6. The method of claim 4, wherein the transport packet further comprises at least a header syntax identifier and a single shared identifier associated with all of the fragments of the at least one XML-based content sample.

7. The method of claim 4, wherein the transport packet further comprises at least a header syntax identifier and a value indicating a total number of fragments that the at least one XML-based content sample was partitioned into.

8. The method of claim 3, wherein the type of partitioning performed on the at least one XML-based content sample comprises partitioning the at least one content sample into fragments to preserve any underlying syntactic structure associated with the at least one content sample.

9. The method of claim 8, wherein the transport packet further comprises at least a header syntax identifier and a nesting identifier, the nesting identifier denoting one of either a level of nesting from a parent XML element and an end tag of the parent XML element.

10. The method of claim 8, wherein the transport packet further comprises at least a header syntax identifier, a nesting identifier, the nesting identifier denoting one of either a level of nesting from a parent XML element and an end tag of the parent XML element, and a total number of fragments that the at least one XML-based content sample was partitioned into.

11. An apparatus configured to stream content to a receiver, comprising:
a processor; and
a memory operatively connected to the processor and including:
computer code for partitioning at least one XML-based content sample into at least two fragments;
computer code for generating a transport packet for each of the at least two fragments;
computer code for encapsulating each of the at least two fragments in a payload field within their respective transport packets, wherein each of the respective transport packets also contains a fragmentation type field; and
computer code for transporting the respective transport packets for reassembly of the at least one XML-based content sample at the receiver using the at least two fragments.

12. The apparatus of claim 11, wherein the transport packet further comprises a sample type field indicating a type of content that is contained in the payload field.

13. The apparatus of claim 11, wherein the fragmentation type field indicates a type of partitioning performed on the at least one XML-based content sample.

14. The apparatus of claim 13, wherein the type of partitioning performed on the at least one content sample comprises partitioning the at least one XML-based content sample into fragments regardless of any underlying syntactic structure associated with the at least one XML-based content sample.

15. The apparatus of claim 14, wherein the transport packet further comprises at least a header syntax identifier, a start flag set in a first one of the at least two fragments, and an end flag set in a last one of the at least two fragments.

16. The apparatus of claim 14, wherein the transport packet further comprises at least a header syntax identifier and a single shared identifier associated with all of the fragments of the at least one XML-based content sample.

17. The apparatus of claim 14, wherein the transport packet further comprises at least a header syntax identifier and a value indicating a total number of fragments that the at least one XML-based content sample was partitioned into.

18. The apparatus of claim 13, wherein the type of partitioning performed on the at least one XML-based content sample comprises partitioning the at least one XML-based content sample into fragments to preserve any underlying syntactic structure associated with the at least one content sample.

19. The apparatus of claim 18, wherein the transport packet further comprises at least a header syntax identifier and a nesting identifier, the nesting identifier denoting one of either a level of nesting from a parent XML element and an end tag of the parent XML element.

20. The apparatus of claim 18, wherein the transport packet further comprises at least a header syntax identifier, a nesting identifier, the nesting identifier denoting one of either a level of nesting from a parent XML element and an end tag of the parent XML element, and a total number of fragments that the at least one XML-based content sample was partitioned into.

21. A computer program product, embodied on a computer-readable medium, for streaming content to a receiver, comprising:
computer code for partitioning at least one XML-based content sample into at least two fragments;
computer code for generating a transport packet for each of the at least two fragments;
computer code for encapsulating each of the at least two fragments in a payload field within their respective transport packets, wherein each of the respective transport packets also contains at least a fragmentation type field; and
computer code for transporting the respective transport packets for reassembly of the at least one XML-based content sample at the receiver using the at least two fragment.

22. A method for receiving streamed content, comprising:
receiving at least two transport packets, wherein each of the at least two transport packets contains a fragmentation type field and a payload field containing a fragment of at least one XML-based content sample; and
reassembling the at least one XML-based content sample using the at least two fragments

23. The method of claim 22, wherein the computer code for the reassembly of the at least one XML-based content sample further comprises computer code for performing one of a plurality of actions including:
reassembling the at least one XML-based content sample completely if all of the at least two fragments have been received by the receiver;
requesting retransmission of any of the at least two fragments that were not received by the receiver; and
performing error concealment by continuing reassembly of the at least one XML-based content sample despite missing any of the at least two fragments that were not received by the receiver.

24. The method of claim 23, wherein the transport packet further comprises at least a header syntax identifier and a value indicating a total number of fragments that the at least one XML-based content sample was partitioned into.

25. The method of claim 24, wherein each of the at least two fragments is associated with a sequence number and a priority value, which in conjunction with the total number of fragments, is used to determine if any of the at least two fragments are missing and are candidates for retransmission and error concealment.

26. The method of claim 23, wherein the fragmentation type field indicates a type of partitioning performed on the at least one XML-based content sample, the type of partitioning further comprising, partitioning the at least one XML-based content sample into fragments to preserve any underlying syntactic structure associated with the at least one XML-based content sample.

27. The method of claim 26, wherein the transport packet further comprises at least a header syntax identifier and a nesting identifier, the nesting identifier denoting one of either a level of nesting from a parent XML element and an end tag of the parent XML element.

28. The method of claim 27, wherein each of the at least two fragments is associated with a sequence number, which in conjunction with the nesting identifier, is used to determine if any of the at least two fragments are missing, are candidates for retransmission and error concealment, and if so, where in a transport sequence of fragments any of the at least two fragments that are missing belong for proper reassembly of the least one XML-based content sample.

29. The method of claim 26, wherein the transport packet further comprises at least a header syntax identifier, a nesting identifier, the nesting identifier denoting one of either a level of nesting from a parent XML element and an end tag of the parent XML element, and a total number of fragments that the at least one XML-based content sample was partitioned into.

30. The method of claim 29, wherein each of the at least two fragments is associated with a sequence number, which in conjunction with the nesting identifier and the total number of fragments that the at least one XML-based content sample was partitioned into, is used to determine if any of the at least two fragments are missing, are candidates for retransmission and error concealment, and if so, where in a transport sequence of fragments any of the at least two fragments that are missing belong for proper reassembly of the least one XML-based content sample.

31. An apparatus configured to receive streamed content, comprising:
a processor; and
a memory operatively connected to the processor and including:
computer code for receiving at least two transport packets, wherein each of the at least two transport packets contains a fragmentation type field and a payload field containing a fragment of at least one XML-based content sample; and
computer code for reassembling the at least one XML-based content sample using the at least two fragments.

32. The apparatus of claim 31, wherein the computer code for the reassembly of the at least one XML-based content sample further comprises computer code for performing one of a plurality of actions including:
reassembling the at least one XML-based content sample completely if all of the at least two fragments have been received by the receiver;
requesting retransmission of any of the at least two fragments that were not received by the receiver; and
performing error concealment by continuing reassembly of the at least one XML-based content despite missing any of the at least two fragments that were not received by the receiver.

33. The apparatus of claim 32, wherein the fragmentation type field indicates a type of partitioning performed on the at least one XML-based content sample, the type of partitioning further comprising, partitioning the at least one XML-based content sample into fragments regardless of any underlying syntactic structure associated with the at least one XML-based content sample.

34. The apparatus of claim 33, wherein the transport packet further comprises at least a header syntax identifier and a value indicating a total number of fragments that the at least one XML-based content sample was partitioned into.

35. The apparatus of claim 33, wherein each of the at least two fragments is associated with a sequence number and a priority value, which in conjunction with the total number of fragments, is used to determine if any of the at least two fragments are missing and are candidates for retransmission and error concealment.

36. The apparatus of claim 32, wherein the fragmentation type field indicates a type of partitioning performed on the at least one XML-based content sample, the type of partitioning further comprising, partitioning the at least one XML-based content sample into fragments to preserve any underlying syntactic structure associated with the at least one XML-based content sample.

37. The apparatus of claim 36, wherein the transport packet further comprises at least a header syntax identifier and a nesting identifier, the nesting identifier denoting one of either a level of nesting from a parent XML element and an end tag of the parent XML element.

38. The apparatus of claim 37, wherein each of the at least two fragments is associated with a sequence number, which in conjunction with the nesting identifier, is used to determine if any of the at least two fragments are missing, are candidates for retransmission and error concealment, and if so, where in a transport sequence of fragments any of the at least two fragments that are missing belong for proper reassembly of the least one XML-based content sample.

39. The apparatus of claim 36, wherein the transport packet further comprises at least a header syntax identifier, a nesting identifier, the nesting identifier denoting one of either a level of nesting from a parent XML element and an end tag of the parent XML element, and a total number of fragments that the at least one XML-based content sample was partitioned into.

40. The apparatus of claim 39 wherein each of the at least two fragments is associated with a sequence number, which in conjunction with the nesting identifier and the total number of fragments that the at least one XML-based content sample was partitioned into, can be used to determine if any of the at least two fragments are missing, are candidates for retransmission and error concealment, and if so, where in a transport sequence of fragments, any of the at least two fragments that are missing belong for proper reassembly of the least one XML-based content sample.

41. A computer program product, embodied on a computer-readable medium, for receiving streamed content, comprising:
computer code for receiving at least two transport packets, wherein each of the at least two transport packets contains a fragmentation type field and a payload field containing a fragment of at least one XML-based content sample; and
computer code for reassembling the at least one XML-based content sample using the at least two fragments.
